(19) United States
(12) Patent Application Publication
(10) Pub. No.: US 2011/0181959 A1
(43) Pub. Date: Jul. 28, 2011

(54) KALEIDOSCOPIC SYSTEM AND METHOD OF USE

(76) Inventor: Marcia Clark, McMurray, PA (US)

(21) Appl. No.: 13/013,458

(22) Filed: Jan. 25, 2011

Related U.S. Application Data
(60) Provisional application No. 61/297,978, filed on Jan. 25, 2010.

(51) Int. Cl. G02B 27/08; F16M 11/00; F16M 13/00

(52) U.S. Cl. 359/616; 248/122.1

(57) ABSTRACT

A kaleidoscopic system may include a portable platform table having at least one storage compartment, a teleidoscope mounted on a swivel and gooseneck assembly, and a turntable affixed to a top of the portable platform table. The assembly may be affixed to the portable platform table to position the teleidoscope over the turntable.

### RELATED APPLICATIONS AND CLAIM OF PRIORITY

This application claims priority to U.S. Provisional Patent Application No. 61/297,978, filed Jan. 25, 2010, the disclosure of which is incorporated herein by reference.

Not applicable.

### BACKGROUND

The disclosed embodiments generally relate to the field of kaleidoscopes. More particularly, the embodiments relate to a type of kaleidoscope generally known as a teleidoscope.

Kaleidoscopes are well-known optical devices, popularly sold as children's toys and also sold as pieces of art. A kaleidoscope traditionally is made of a long hollow tube or box shape containing two or three mirrored surfaces assembled in varying configurations. At one end is an optical focusing lens. At the other end is a compartment that may contain small colored objects. These objects are seen through the eyepiece as multiple patterns that are created by the arrangement of the minors. Reflections are ever changing as the kaleidoscope is turned and the objects fall into random positions in the compartment.

There is a type of kaleidoscope which is called a teleidoscope. The teleidoscope traditionally includes a long hollow tube containing two or three mirrored surfaces assembled in varying configurations. At one end is a weak optical focusing lens. The other end may be open, or the other end may hold a glass, plastic or acrylic sphere instead of a compartment filled with objects. The pattern and images formed while looking through a teleidoscope are formed by moving the teleidoscope and viewing one's environment through the teleidoscope. The proximal environment becomes the ever changing image.

Most frequently, teleidoscopes are held in the user's or viewer's hand and moved by the user to view an area in their environment. The mirror system provides changing reflections as the teleidoscope is moved and the environment scanned. Occasionally, the teleidoscope is affixed to a pedestal or onto a fixed frame, and objects are placed under the teleidoscope and viewed by looking through the teleidoscope. When permanently mounted on a pedestal or a frame, the teleidoscope is at a fixed angle which constrains the range of motion of the teleidoscope and it also limits the viewer's field of vision through the fixed unit.

The disclosure contained herein describes attempts to address one or more of the problems described above.

### SUMMARY

Before the present methods, systems, and materials are described, it is to be understood that this disclosure is not limited to the particular methodologies, systems, and materials described, as this may vary. The terminology used in the description is for the purpose of describing the particular versions or embodiments only, and is not intended to limit the scope.

As used herein and in the appended claims, the singular forms “a,” “an,” and “the” include plural references unless the context clearly dictates otherwise. Unless defined otherwise, all technical and scientific terms used herein have the same meanings as commonly understood by one of ordinary skill in the art. Although any methods, systems, and materials similar or equivalent to that described herein can be used in the practice or testing of embodiments, the preferred methods, systems, and materials are now described. As used herein, the term “comprising” means “including, but not limited to.”

In an embodiment, a kaleidoscopic system may include a portable platform table having a tabletop member and at least one integral storage compartment. A teleidoscope is mounted on a swivel and gooseneck assembly that is attached to the tabletop member. A turntable is also affixed to a top portion of the tabletop member.

In some embodiments, one or more of the integral storage compartments may have an opening that is positioned on a side of the tabletop member, as well as one or more shelves. Alternately, the storage compartment includes an opening at a top portion of the tabletop member, a cavity that extends into the tabletop member and (optionally) into one of the legs, and a floor surface that is optionally at a level above a bottom portion of the portable platform table. The teleidoscope may be mounted on the swivel and gooseneck assembly via a cradle, and it may swivel in a plane that is perpendicular to a direction of an end of the gooseneck near the teleidoscope. The teleidoscope may be configured to swivel in a counter-clockwise direction and/or clockwise direction. The swivel and gooseneck assembly may be flexible and removably secured to a post that is permanently attached to the top of the portable platform table. If so, a bottom end of the swivel and gooseneck assembly may include an internal receptacle holding one or more bearings, such that the bearing(s) will fit snugly and snaps into a groove of the post.

In some embodiments, a support structure is affixed to a bottom surface of the portable platform table. The support structure may be configured to stably elevate the bottom surface of the portable platform table above a working surface. In some embodiments, The support structure may include a receptacle having an open top and a closed bottom. A non-skid surface may be affixed to a bottom of the at least one support structure. In some embodiments, the support structure may include legs that support the tabletop member. If so, the cavity of at least one of the storage compartments may extend into at least one of the legs.

In some embodiments, the turntable may have a turning assembly that attaches the turntable to the portable platform table. The turntable may be configured to rotate 360 degrees. One or more objects may be positioned on top of the turntable and configured to be viewed through the teleidoscope.

In an alternate embodiment, a method of using a kaleidoscopic system includes providing a kaleidoscopic system that a portable platform table comprising: (a) at least one storage compartment; (b) a swivel and gooseneck assembly affixed to the portable platform table; (c) a teleidoscope mounted on the swivel and gooseneck assembly; and (d) a turntable affixed to a top portion of the portable platform table. The method includes positioning one or more objects on the turntable, and turning (by a motor and drive assembly) the turntable in a clockwise or counter-clockwise direction so that a user may view the one or more objects through the teleidoscope as they move on the turntable.

### BRIEF DESCRIPTION OF THE DRAWINGS

Aspects, features, benefits and advantages of the present application will be apparent with regard to the following description and accompanying drawings, of which:

FIG. 1 depicts a prior art kaleidoscope using two to three mirrors known to a person of skill in the art.

FIG. 2 depicts a prior art teleidoscope using two to three minors known to a person of skill in the art.

FIG. 3 depicts a first embodiment of a kaleidoscopic system including a portable platform table with storage compartments, a turntable affixed to the top of the portable platform table, and a teleidoscope mounted on a gooseneck and swivel assembly that is also affixed to the top of the portable platform table according to various embodiments.

FIG. 4 depicts a second embodiment of a kaleidoscopic system.

FIG. 5 depicts a third embodiment of a kaleidoscopic system.

FIG. 6 is an exploded view of a swivel and gooseneck assembly of the kaleidoscopic system connected to a post affixed to the top of the portable platform table according to an embodiment.

FIG. 7 depicts a flow diagram of an exemplary method of using a kaleidoscopic system according to an embodiment.

### DETAILED DESCRIPTION

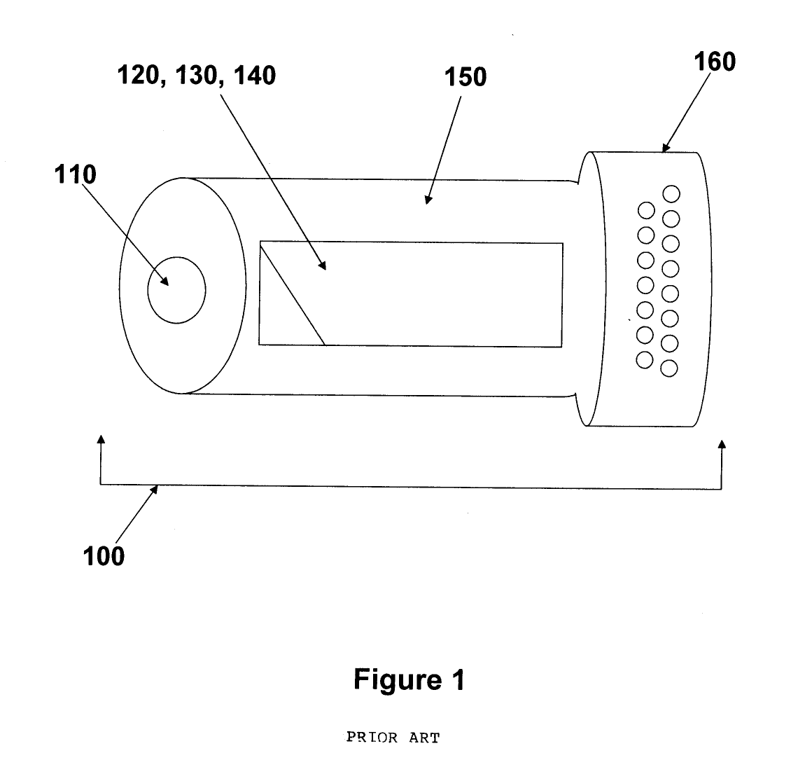

FIG. 1 depicts a prior art kaleidoscope using two to three mirrors known to a person of skill in the art. FIG. 1 shows a traditional standard kaleidoscope, assembled from a focusing lens 110, two or three mirrors 120, 130, and 140, assembled into a triangular shaped internally mirrored tunnel 150, an object cell 160 containing the beads, confetti, or other decorative, multi-colored objects, and a housing 100 to hold it all together.

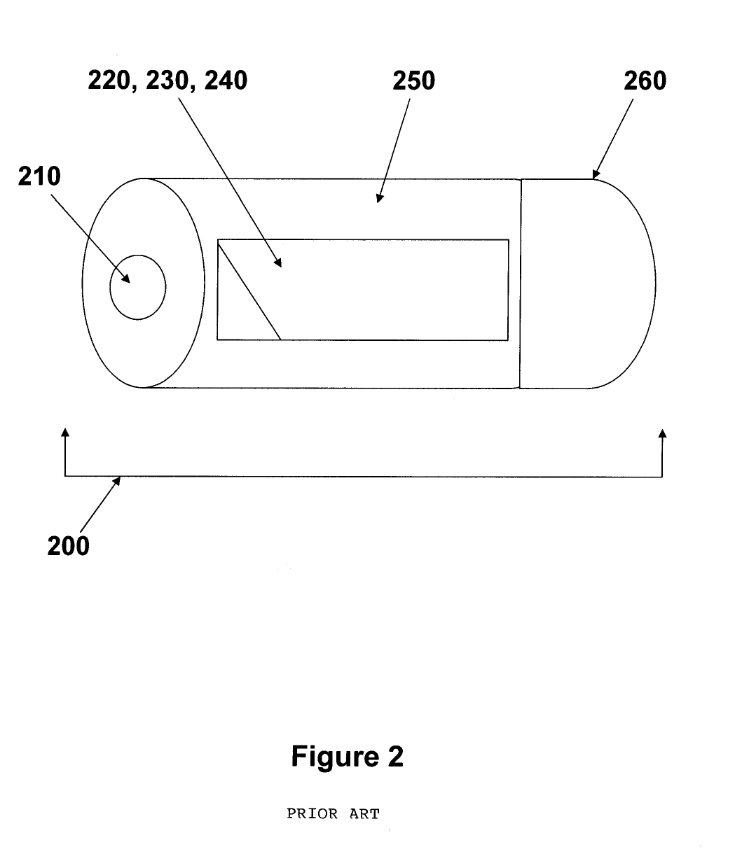

FIG. 2 depicts a prior art teleidoscope using two to three minors known to a person of skill in the art. FIG. 2 shows a standard teleidoscope, assembled from a focusing lens 210, two or three mirrors 220, 230 and 240 assembled into a triangular-shaped internally-mirrored tunnel 250, an optical sphere 260 which may be made of glass, plastic, acrylic, or a different material, and a housing 200 to hold it all together. The teleidoscope is similar to the kaleidoscope in FIG. 1, but instead of an object cell it has a ball lens or optical sphere 260. Optical sphere 260 is transparent so that a viewer may look through lens 210 and see objects that are located beyond the sphere 260.

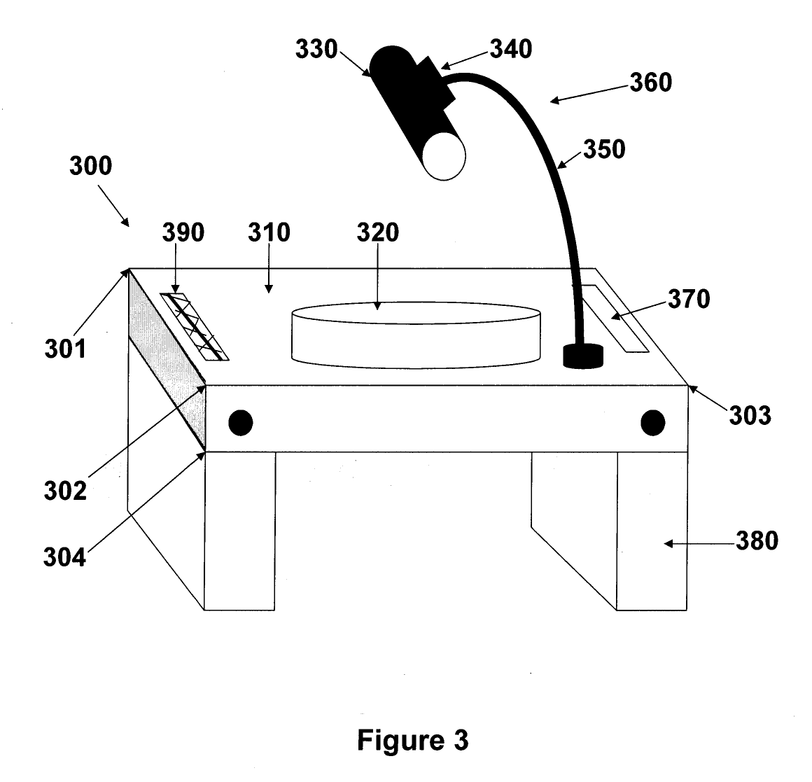

In accordance with various embodiments, as illustrated in FIGS. 3-5, a kaleidoscope system may include a portable platform table 300 including at least one integral storage compartment 370, a teleidoscope 330 mounted on a swivel and gooseneck assembly 360, and a turntable 320 affixed to a tabletop member 310.

As shown in FIG. 3, the portable platform table 300 may include tabletop member 310, which is shown to be rectangular, although other shapes are possible. The portable platform table 300 may have a width that is a distance across a first corner 301 and a second corner 302, a length that is a distance across a second corner 302 and a third corner 303, and a height that is a distance between a second corner 302 and a fourth corner 304. In an embodiment, the tabletop member 310 may have a height ranging from two to three inches.

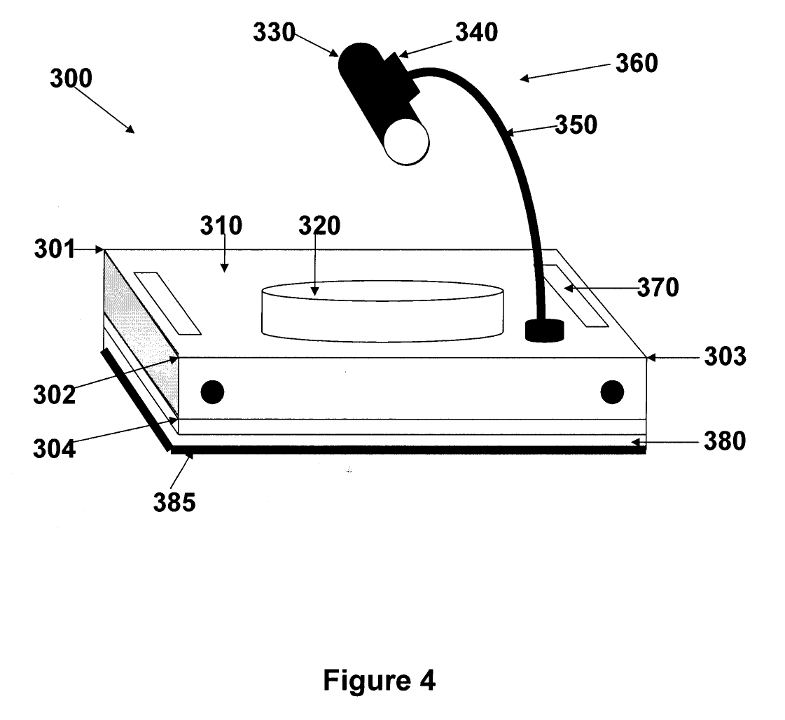

In an embodiment as shown in FIG. 4, at least one support structure 304 may be affixed to a bottom surface of the tabletop member 310. The support structure(s) may be positioned to stably elevate the bottom surface of the portable table above a working surface. In an embodiment, any or all of the support structure(s) may include a hollowed portion that is a receptacle having an open top and a partially or fully closed bottom. In an embodiment, and as depicted in FIG. 4, a non-skid surface 385 may be affixed to the bottom of the portable platform table 300 and may be a rubber strip and/or a like structure.

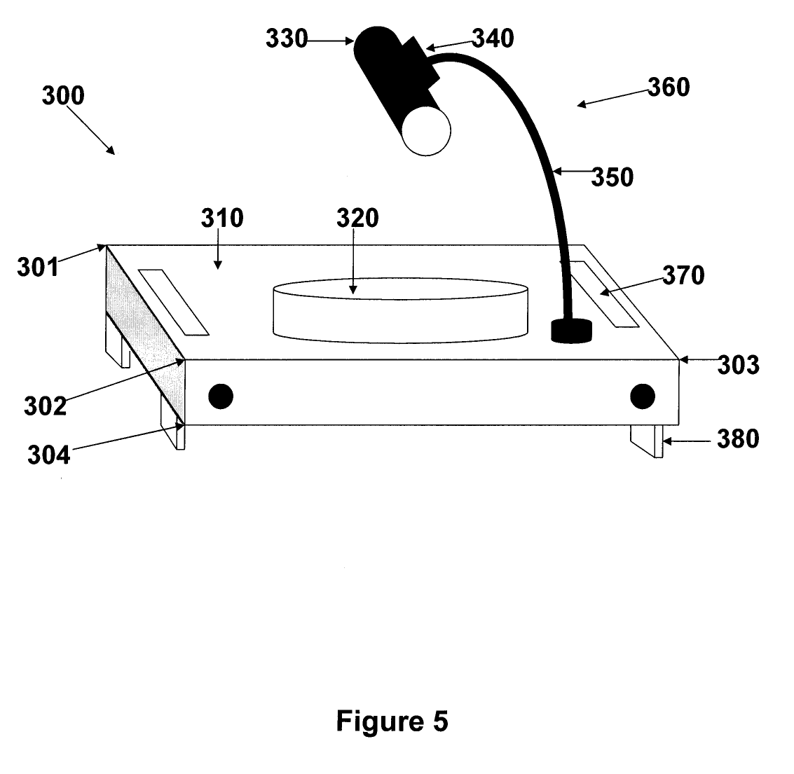

In another embodiment, and as shown in FIG. 3, the support structure(s) may include two, four or more legs 380. In an embodiment, a non-skid surface such as pads or a strip of soft rubber material may be affixed to a bottom portion of each of the legs 380. If two legs are present, each of the legs 380 may run along the edge to extend along all or substantially all of the width of a side of the top of the tabletop member 310. The platform table 300 may include one or more storage compartments 370 to hold paper, pencils and markers on one side and various objects (not shown) on the opposing side of the table 300. As shown in FIG. 5, if four legs 380 are present, they may extend downward from corners of the tabletop member 310.

The storage compartments 370 may be rectangular, square and/or a like shape appropriate to hold various objects. In an embodiment, the tabletop member 310 may include one or more storage compartments 370 positioned over the legs 380 so that the holding area of each storage component extends into one of the legs 380. A storage compartment may include an opening at a level that is at the top surface of the tabletop member 310, and at least one adjacent side surface that connects the top surface of the storage compartment to the top surface of the tabletop member 310. Additionally, a storage compartment may include a floor surface at a level above a bottom surface of the tabletop member 310, and at least one adjacent side surface that connects the top surface of the storage compartment to the bottom surface of the tabletop member 310. The opening, side surfaces, and floor surfaces together form a cavity that extends into the tabletop member. Alternatively, each of the storage compartments may extend into a side of the tabletop member such that the side has an opening and the compartment extends into a hollow portion of the tabletop member.

A storage compartment 370 that extends into one of the legs 380 may be narrow and deep to accept paper in a lengthwise direction. Additionally, a storage compartment may be positioned over or underneath the tabletop member 310 and may be sized and shaped to store the teleidoscope and gooseneck assembly 360 for ease of shipping. Alternatively, and as shown in FIG. 3, the storage compartment 370 may include one or more dividers 390, which may be used as shelves or which may form the sidewalls of one or more compartments. In an embodiment, the dividers 390 may be removable. Optionally, the storage compartment 370 may include an opening at the bottom or along a sidewall to facilitate cleaning of the storage compartment.

Referring back to FIG. 3, the portable platform table 300 may have a width that is greater than the hip size of an average sized adult so that the portable platform table 300 may be positioned across and over a person in a sitting or lying position by use of the space. The space may be a distance between internal side surfaces of opposing support structures in a direction corresponding to the length of the portable platform table 300. For example, if a person is using the system in bed, the legs 380 may be positioned and fit over the person's outstretched legs. Thus, the width of the tabletop member 310 at its widest point may be 34″, 36″, 38″, 40″ or another width. The assembly system may also be portable and be placed on an exiting table or on the floor.

The swivel and gooseneck assembly 360 may be affixed to the top of the portable platform table 300 as shown in FIG. 3, or it may be affixed to a side of the table. In an embodiment, the teleidoscope may be affixed to and mounted onto a flexible metal gooseneck 350 and the assembly 360 may be affixed to a top or side of the platform table 300 to position the teleidoscope 340 over the turntable 320. The teleidoscope 330 may swivel about, be fixed to, or be mounted to the gooseneck 350 via a swivel or cradle feature 340. The teleidoscope 330 may swivel in a plane perpendicular to a direction of an end of the gooseneck that is closest to the teleidoscope. The teleidoscope 330 may swivel in a clockwise and/or counter-clockwise direction. In an embodiment, the swivel 340 may connect to the gooseneck 350 via male and female threaded ends. The gooseneck 350 may be made of a flexible metal and/or a like material. For example, the gooseneck 350 may be made from interlocking rolled metal to provide for its flexibility. The gooseneck 350 may enable a viewer to personally adjust the placement of the teleidoscope 330 for the viewer's best and most comfortable viewing range so that the viewer may see objects (not shown) on the turntable 320 with more ease. This also offers the viewer a larger viewing area.

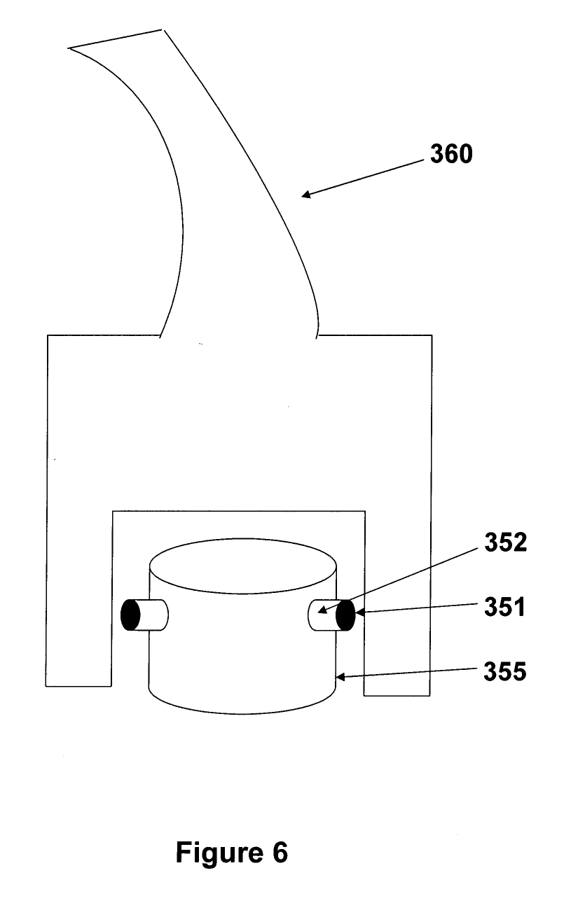

FIG. 6 depicts an exploded view of a swivel and gooseneck assembly 360 of the kaleidoscopic system connected to a post 355 affixed to the top of the portable platform table according to an embodiment. In an embodiment, the swivel and gooseneck assembly 360 may be removably secured to a post 355. The post 355 may be permanently attached to the top of the portable platform table and may include at least one groove 352. A bottom end of the swivel and gooseneck assembly 360 may include an internal receptacle that has at least one bearing 351. The at least one bearing 351 may fit snugly and snap into the at least one groove 352 of the post 355. The bearing 351 or bearings may push inward upon application of force so that it may be pulled out of the at least one groove 352, allowing the swivel and gooseneck assembly 360 to be removed from the post 355. Alternatively, the post may contain the bearing and the interior of the gooseneck assembly may contain the grooves. Other snap-fit structures are possible.

The turntable 320 may be mounted over the tabletop member 310, or embedded into a top portion of the tabletop member 310, via a central axle, and the turntable 320 may spin about the central axle. A ball bearing positioned under the tabletop member 310 may connect the central axle to the turntable member 310. Alternatively, a nut, which is a hardware fastener with an internally threaded hole, may be fastened to a threaded portion of the central axle. The turntable 320 may manually be spun around the central axle. Alternatively, a motor connected to a power supply may be positioned under the tabletop member 310 and may spin the turntable 320 around the central axle. Custom designs, logos, and/or messages can be sealed on a surface of the turntable 320 recognizing sponsors, donors and/or the like.

Alternatively, the turntable 320 may have a turning assembly (not shown). The turning assembly may attach the turntable 320 to the tabletop member 310 of the portable platform table 300. In an embodiment, the turning assembly may include a counter-weight. One or more sleeves may surround a central axle connecting the counter-weight to a bottom center portion of the portable platform table 300 and the turntable 320 to a top center portion of the tabletop member 310. A threaded screw and nut assembly may secure the central axle, counter-weight, and turntable 320 to a center portion of the portable platform table 300.

The turning assembly may be permanently attached to a top center position of the portable platform table 300. In an embodiment, objects may be positioned on top of a turntable 320 and viewed through a teleidoscope 330. The turntable 320 may turn in a continuous 360 degree movement either in a clockwise or a counter-clockwise direction.

The turntable 320 may be turned manually, or a motor (not shown) may turn the turntable 320 if connected to a power supply. In an embodiment, the turntable 320 may be made of acrylic, metal, or another material, and the objects may include pictures, drawings, created art, and/or the like. In an embodiment with a metal turntable 320, the system may include magnets, which a user may position to hold objects in place on the turntable 320.

A viewer may view objects placed on the turntable 320 through the teleidoscope. In an embodiment, the teleidoscope 330 may be manually adjusted. Additionally, the turntable 320 may be manually turned. The turning assembly may include a compartment underneath the portable platform table 300. In an embodiment, the top of the portable platform table 300 may house the turntable 320 in the center of the tabletop 310 and the teleidoscope and gooseneck assembly 360 may be adjacent and proximal to the turntable 320.

In an embodiment, the teleidoscope 330 may be made of an acrylic, glass, wood, metal, or other material. Acrylic material made be used over glass for safety purposes. However, either material and/or like material that may be cleaned with alcohol are within the scope of this disclosure and may be used.

In an embodiment, a viewer may place art that the viewer has created, pictures, or various other objects on the turntable 320. The viewer may adjust the teleidoscope 330 for personal ease of viewing and comfort. The viewer may look at the object placed on the turntable 320 through the adjusted teleidoscope 330. In an embodiment, rotating the turntable 320 may provide additional views through the changing array of images as seen through the teleidoscope 330.

In an embodiment, the system may be large-scale in design. Additionally, the system may include multiple gooseneck, cradle and teleidoscope assemblies on a table so that multiple users may use the system at the same time.

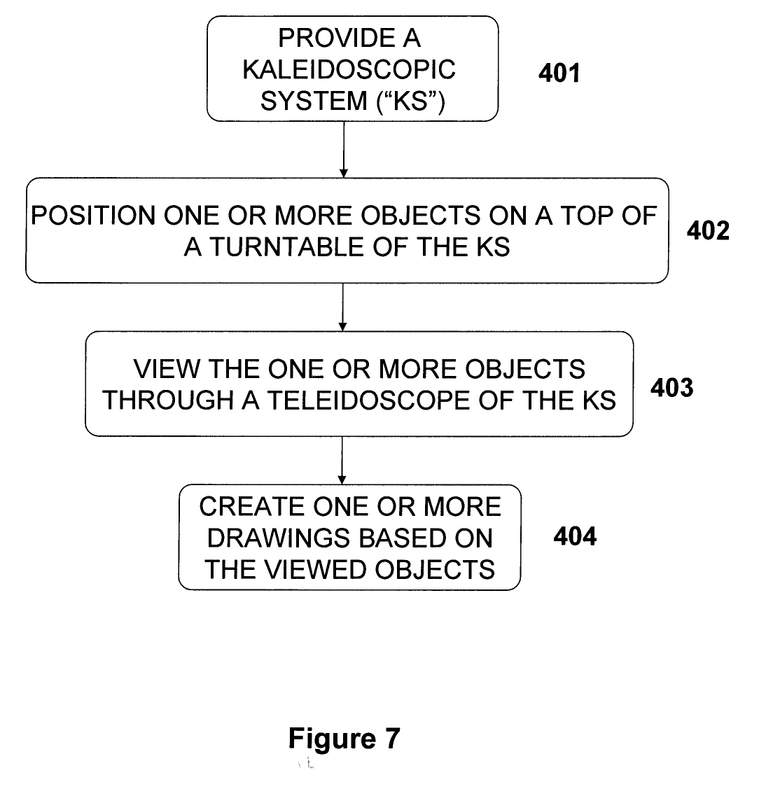

FIG. 7 depicts a flow diagram of an exemplary method of using a kaleidoscopic system according to an embodiment. A kaleidoscopic system may be provided 401. The kaleidoscopic system may include a portable platform table with at least one storage compartment, a teleidoscope mounted on a swivel and gooseneck assembly, and a turntable affixed to a top of the portable platform table. The assembly may be affixed to the top of the portable platform table. One or more objects may be positioned 402 on top of the turntable. A motor and drive assembly may turn the turntable so that a viewer can view the objects through the teleidoscope as the objects are moved by the turntable. One or more objects may be viewed 403 through the teleidoscope. One or more drawings may be created 404 based on the viewed objects.

In an embodiment, the turntable may be turned while the objects are viewed 403. Additionally, the turntable may be turned by rotating the turntable in a counter-clockwise direction and/or a clockwise direction. In another embodiment, the portable platform table may be adjusted across and over a person that is in a sitting or lying position. In an embodiment, the swivel and gooseneck assembly may be manually adjusted for viewing comfort. In an embodiment, the kaleidoscopic system may be used for art therapy, distraction therapy, relaxation, pleasure and/or within like circumstances. For example, the kaleidoscopic system may be used in the treatment of those individuals with autism, dementia, attention deficit disorder, and/or a like disorder.

Some or all of the features and functions disclosed above, or alternatives thereof, may be desirably combined into many other different systems or applications. Various presently unforeseen or unanticipated alternatives, modifications, variations or improvements therein may be subsequently made by those skilled in the art, and are also intended to be encompassed by the following claims.

What is claimed is:

1. A kaleidoscopic system, comprising:
a portable platform table comprising a tabletop member and at least one integral storage compartment that extends into the tabletop member;
a swivel and gooseneck assembly affixed to the tabletop member;
a teleidoscope mounted on the swivel and gooseneck assembly; and
a turntable affixed to a top portion of the tabletop member.

2. The kaleidoscopic system of claim 1, wherein the at least one integral storage compartment has an opening that is positioned on a side of the tabletop member and comprises one or more shelves.

3. The kaleidoscopic system of claim 1, wherein the at least one storage compartment comprises:
an opening at a top portion of the tabletop member;
a cavity that extends into the tabletop member; and
a floor surface at a level above a bottom portion of the portable platform table.

4. The kaleidoscopic system of claim 1, wherein the teleidoscope is:
mounted on the swivel and gooseneck assembly via a cradle; and
swivels in a plane perpendicular to a direction of an end of the gooseneck near the teleidoscope.

5. The kaleidoscopic system of claim 4, wherein the teleidoscope is configured to swivel in one or more of a counter-clockwise direction and a clockwise direction.

6. The kaleidoscopic system of claim 1, wherein at least one support structure is affixed to a bottom surface of the portable platform table, wherein the at least one support structure is configured to stably elevate the bottom surface of the portable platform table above a working surface.

7. The kaleidoscopic system of claim 6, wherein the at least one support structure comprises a receptacle having an open top and a closed bottom.

8. The kaleidoscopic system of claim 7, further comprising a non-skid surface affixed to a bottom of the at least one support structure.

9. The kaleidoscopic system of claim 1, further comprising a plurality of legs that support the tabletop member, and wherein at least one of the storage compartments extends into at least one of the legs.

10. The kaleidoscopic system of claim 1, wherein the swivel and gooseneck assembly is flexible and is removably secured to a post, wherein the post is permanently attached to the top of the portable platform table and comprises a groove.

11. The kaleidoscopic system of claim 10, wherein a bottom end of the swivel and gooseneck assembly comprises an internal receptacle comprising at least one bearing, wherein the at least one bearing fits snugly and snaps into the groove.

12. The kaleidoscopic system of claim 1, wherein:
the turntable has a turning assembly, and
the turning assembly attaches the turntable to the portable platform table.

13. The kaleidoscopic system of claim 12, wherein the turntable is configured to rotate 360 degrees.

14. The kaleidoscopic system of claim 12, further comprising one or more objects positioned on top of the turntable and configured to be viewed through the teleidoscope.

15. A method of using a kaleidoscopic system, comprising:
providing a kaleidoscopic system, comprising:
a portable platform table comprising at least one storage compartment,
a swivel and gooseneck assembly affixed to the portable platform table,
a teleidoscope mounted on the swivel and gooseneck assembly, and
a turntable affixed to a top portion of the portable platform table,
positioning one or more objects on the turntable; and
turning, by a motor and drive assembly, the turntable so that a user may view the one or more objects through the teleidoscope as they move on the turntable.

16. The method of claim 15, wherein turning the turntable comprises rotating the turntable in one or more of the following directions: a clockwise direction and a counter-clockwise direction.
